(19) United States
(12) Patent Application Publication
(10) Pub. No.: US 2015/0222950 A1
(43) Pub. Date: Aug. 6, 2015

(54) METHOD OF IDENTIFYING MEDIA CONTENT

(71) Applicant: OMNIFONE LTD., London (GB)

(72) Inventors: Philip Anthony Sant, London (GB); Neal Hart, London (GB); Mark Knight, London (GB)

(21) Appl. No.: 14/421,758

(22) PCT Filed: Aug. 21, 2013
(86) PCT No.: PCT/GB2013/052204

§ 371 Date: Feb. 13, 2015

(30) Foreign Application Priority Data
Aug. 21, 2012 (GB) 1214842.5

(51) Int. Cl. H04N 21/439; H04N 21/433; H04N 21/84; H04N 21/24; H04N 21/4627; H04N 21/258; H04N 21/239; H04N 21/422; H04N 21/466

(52) U.S. Cl. CPC H04N 21/4394; H04N 21/42203; H04N 21/4334; H04N 21/84; H04N 21/4667; H04N 21/4627; H04N 21/25883; H04N 21/239; H04N 21/2407

(57) ABSTRACT

There is disclosed a method for identifying media content playing in a vicinity of a device, the method including the steps of: (a) recording sounds received at the device; (b) analysing those sounds to determine which media content is playing in the vicinity of the device, and (c) storing or transmitting results of the analysis to permit a generation of a report as to what specific media content is playing in the vicinity of the device, or was playing in the vicinity of the device. There are further disclosed related devices and related computer program products.

### BACKGROUND OF THE INVENTION

1. Field of the Invention

The field of the invention relates to methods for identifying media content playing in the vicinity of a device, especially to methods for allowing the generation of reports such as for the purposes of tracking, licensing, or the production of charts, or other such uses. The field of the invention further relates to related devices and to related computer program products.

2. Technical Background

Historically, it has been possible to track the popularity of media content using only crude measures such as counting the number of copies purchased and/or downloaded. Until very recently, tracking the listening or watching habits of consumers had to rely on very primitive means, such as interviews of statistically significant samples of the target market and extrapolating from that data.

Such approaches allow for broad information to be collected, but have left the detail of people's actual listening largely unexamined, resulting in the situation which obtains today, where—for example—radio stations are unaware of the actual listening preferences of their target audience other than in broad, general terms.

For example, if a given radio station plays classic rock at a certain time of day then only very crude—and often expensive to carry out—surveys of their target market are able currently to provide information about the popularity of that music at that time. Details such as where, geographically, a given genre, channel or track is more or less popular are effectively impossible to obtain, leaving the station with only broad, sweeping primitive statistical tools to assist in guiding the design of their programming.

Examples of the present invention provide a mechanism whereby the actual listening and watching behaviour of consumers may be noted, regardless of the playback mechanism employed by those consumers. In consequence, radio stations, television stations and other media content producers and distributors are able to gain rich information about their audience's actual listening behaviour to as fine a granularity of detail as desired, the better to structure their programming to attract and keep those audiences.

Such detailed data is of particular utility to radio and television stations, to internet media content streaming sites which wish to see more detailed information, such as to who is viewing their content in the vicinity of the device on which it is being streamed, and to advertisers who wish to know precisely where and when their advertising is actually being listened to or viewed (as opposed to, for example, being skipped or played on a muted device).

As another example, royalty collection bodies, such as the Performing Right Society (PRS), will be able to replace or augment their current, largely manual and highly labour-intensive, system of monitoring playback in bars, clubs, restaurants and cafes and other licensed venues by use of the automatic analyses provided by examples of the present invention. Since examples of the present invention operate at the user level—collecting data about what people are actually listening to and where and when—rather than at a gross audience level, it also permits the recording of what media content is played even when the choice of that media content is interactive, such as when selected on the fly by disc jockeys (DJs), via a jukebox or other interactive mechanisms.

Also, examples of the present invention's capabilities enable more directly relevant distribution of royalties collected, since the actual music played can be precisely identified, in a way that is impossible using previously-available techniques.

3. Discussion of Related Art

Examples of the present invention utilize some pre-existing technologies in the computing and audio analysis fields, most relevantly technologies to derive a unique digital fingerprint from a portion of recorded audio and/or video and related technologies designed to clean up ambient audio prior to its identification, such as those utilised by Shazam™ and related applications.

### SUMMARY OF THE INVENTION

According to a first aspect of the invention, there is provided a method of identifying media content playing in a vicinity of a device, the method including the steps of:

(a) recording sounds received at the device;
(b) analysing those sounds to determine which media content is playing in the vicinity of the device, and
(c) storing or transmitting results of the analysis to permit a generation of a report as to what specific media content is playing in the vicinity of the device, or was playing in the vicinity of the device.

The method may be one in which the recording of sounds happens continuously.

The method may be one in which the recording of sounds happens at discrete intervals, whether automatically or manually triggered.

The method may be one in which recorded sounds are stored on a device.

The method may be one in which recorded sounds are transmitted to a remote server for analysis.

The method may be one in which ambient noise, static, hiss, background noise, unwanted speech and/or any other unwanted sounds are digitally filtered from the recorded sounds prior to their analysis.

The method may be one in which the recorded sounds are analysed to produce a concise digital description, i.e. a digital fingerprint, of the media content which was recorded.

The method may be one in which the results arising from the analysis of the recorded sounds are stored on a device.

The method may be one in which the results arising from the analysis of the recorded sounds are transmitted to a remote server.

The method may be one in which data which is stored on a device is later transmitted to a remote server.

The method may be one in which information which is stored on a device or transmitted to a remote server is augmented with metadata including but not limited to one or more of: the geographical location in which the media content is playing, the environment, such demographic information about the listener(s) as is available and any other available metadata.

The method may be one in which the digital fingerprint produced is matched against a database of such fingerprints in order to identify the media content being played.

The method may be one in which a sequence of recorded sounds is matched against known radio or television station playlist programmes to identify whether (and which) station or channel is being played in the vicinity of the device.

The method may be one in which the analysis of the media content played in the vicinity of the device is used to generate reports for use by radio and television stations, media content producers, performance rights societies and any other interested parties.

The method may be one in which the reports so produced may be used to compile charts of digital media content playbacks, to monitor the licensing of digital media content or to request royalties due on playback or for any other purpose.

The method may be one in which data transmitted to a remote server is transmitted using a wireless connection, a wired connection or by any other means, including but not limited to Wi-Fi, Bluetooth, the internet or a mobile phone network.

The method may be one in which the device is a mobile computing device, a laptop, a mobile telephone handset, a music player, an in-vehicular digital media system or any other computing device.

According to a second aspect of the invention, there is provided a computer program product embodied on a non-transient storage medium, the computer program product when running on a computing device operable to identify media content playing in a vicinity of the computing device, the computer program product when running on the computing device operable to:

(a) record sounds received at the device;
(b) analyse those sounds to determine which media content is playing in the vicinity of the device, and
(c) store or transmit results of the analysis to permit a generation of a report as to what specific media content is playing in the vicinity of the device, or was playing in the vicinity of the device.

The computer program product may be further operable to perform the method steps according to any aspect of the first aspect of the invention.

According to a third aspect of the invention, there is provided a computing device including a computer program product embodied on a non-transient storage medium, a microphone, and a processor, the computer program product when running on the computing device operable to identify media content playing in a vicinity of the computing device, the computing device configured to:

(a) record sounds received at the device;
(b) analyse those sounds to determine which media content is playing in the vicinity of the device, and
(c) store or transmit results of the analysis to permit a generation of a report as to what specific media content is playing in the vicinity of the device, or was playing in the vicinity of the device.

The computing device may be further configured to perform the method steps according to any aspect of the first aspect of the invention.

### BRIEF DESCRIPTION OF THE DRAWINGS

The above and other aspects of the invention will now be described, by way of example only, with reference to the following Figures, in which:

FIG. 1 shows, in schematic form, an overview of operation of an example of the invention.

### DETAILED DESCRIPTION

Examples of the present invention:

1. Use a microphone to, continuously or discretely, record sounds in the vicinity
2. Analyse those sounds to determine which media content is playing
3. Store or transmit the results of that analysis to permit the generation of reports as to what specific media content is playing in the vicinity of a device implementing an example of the present invention.

The analysis performed may involve processing of the sounds to assist in the identification of specific media content tracks, such as by removing ambient or background noise, static and hiss and/or speech or other conversational sounds and/or otherwise cleaning up the recorded sounds to assist in their identification.

In a preferred embodiment, the sounds so recorded are then processed to obtain a digital fingerprint which may be matched against a database of previously-derived fingerprints to assist in identifying the specific media content.

Once an example of the present invention has identified the media content playing in the vicinity, that information is stored or transmitted for reporting purposes. In a preferred embodiment, the information about which media content is playing is associated with additional metadata, such as the geographical location in which the media content is playing, the environment (such as an in-car media system, a bar or café, and so forth), such demographics of the listener(s) as are available and any other available metadata, including—in a preferred embodiment—matching a sequence of playing media content against known radio or television station playlist programmes to identify whether (and which) station or channel is being listened to.

Having identified both the media content playing and the environment in which that media content is playing, an implementation of the present invention may then, in a preferred embodiment, generate reports for use by radio and television stations, media content producers, performance rights societies and any other interested parties.

### DEFINITIONS

For convenience, and to avoid needless repetition, the terms “music” and “media content” in this document are to be taken to encompass all “media content” which is in digital form or which it is possible to convert to digital form—including but not limited to books, magazines, newspapers and other periodicals, video in the form of digital video, motion pictures, television shows (as series, as seasons and as individual episodes), computer games and other interactive media, images (photographic or otherwise) and music. Specific examples include digital music tracks eg. “The Laughing Policeman” performed by artist Charles Penrose, and “A Transport of Delight” and “The Gnu Song” performed by artists Flanders and Swann.

Similarly, the term “track” indicates a specific item of media content, whether that be a song, a television show, an eBook or portion thereof, a computer game or any other discreet item of media content.

The terms “playlist” and “album” are used interchangeably to indicate collections of “tracks” which have been conjoined together such that they may be treated as a single entity for the purposes of analysis or recommendation.

The terms “digital media catalogue”, “digital music catalogue”, “media catalogue”, “media content catalogue” and “catalogue” are used interchangeably to indicate a collection of tracks and/or albums to which a user may be allowed access for listening purposes. There is no implication that only one such catalogue exists, and the term encompasses access to multiple separate catalogues simultaneously, whether consecutively, concurrently or by aggregation. The actual catalogue utilised by any given operation may be fixed or may vary over time and/or according to the location or access rights of a particular device or end-user.

The abbreviation “DRM” is used to refer to a “Digital Rights Management” system or mechanism used to grant access rights to a digital media content file.

The verbs “to listen”, “to view” and “to play” are to be taken as encompassing any interaction between a human and media content, whether that be listening to audio content, watching video or image content, reading books or other textual content, playing a computer game, interacting with interactive media content or some combination of such activities.

The terms “user”, “consumer”, “end user” and “individual” are used interchangeably to refer to the person, or group of people, whose media content “listening” preferences are analysed and for whom recommendations are made. In all cases, the masculine includes the feminine and vice versa.

The terms “device”, “media content player” and “media player” are used interchangeably to refer to any computational device which is capable of playing digital media content, including but not limited to MP3 players, television sets, home computer systems, mobile computing devices, games consoles, handheld games consoles, vehicular-based media players or any other applicable device or software media player on such a device.

The term “side-load” is used to refer to the transfer of files to any device in which an example of the present invention is instantiated. “Side-loaded files” are those files which are transferred using that mechanism.

The terms “microphone” or “mic” are used interchangeably to refer to any audio and/or video recording system, systems, device or devices used to record, even ephemerally, sounds and/or visuals in the vicinity for the purposes of processing and analysis by examples of the present invention. The actual hardware utilised by any given embodiment of the present invention—whether a condenser, ribbon, carbon, laser, MEMS (MicroElectrical-Mechanical System) or any other type of microphone—is immaterial, only its utility in providing audio and/or video data to examples of the present invention for processing. Thus, for the purposes of the present invention the definition of “microphone”/“mic” is extremely broad, and (for the avoidance of doubt) a software or hardware device capable of reading a digital stream from a previously-recorded or side-loaded digital media content file can also be taken to be included in the definition of “microphone”/“mic” for the purposes of the present invention.

The verb “to record” is used to refer to the storage, however ephemeral, of sounds and/or visuals in the vicinity of a device implementing an example of the present invention via a microphone for the purposes of processing and/or analysis by examples of the present invention. For the avoidance of doubt, reading a digital stream from a previously-recorded or side-loaded digital media content file can also be taken to be included in the definition of “recording” that media content for the purposes of examples of the present invention.

The term “sounds” is used to refer to any media content, whether audio or visual, which may be recorded via a microphone for processing and/or analysis by examples of the present invention.

Sound and/or visual information is deemed to be in the “vicinity” of a device implementing an example of the present invention if it can be detected using the microphone(s) being utilised by a device implementing an example of the present invention, whatever the geographical or spatial relationship of those microphones to the device or devices in which the present invention is instantiated.

### Specific Description

In an example, the present invention provides a mechanism whereby the actual listening and watching behaviour of consumers may be noted, regardless of the playback mechanism employed by those consumers. In consequence, radio stations and other media content producers and distributors are able to gain rich information about their audience's actual listening behaviour to as fine a granularity of detail as desired, the better to structure their programming to attract and keep those audiences.

In an example, the present invention consists of a microphone and a computing device to analyse sounds and/or visuals in the vicinity to determine which specific media content is being played. In a preferred embodiment, the present invention is used in concert with—or embedded into—a device such as one disclosed in WO2012131400A1, which is incorporated by reference, which is able to provide an implementation of the present invention with connectivity to a remote server.

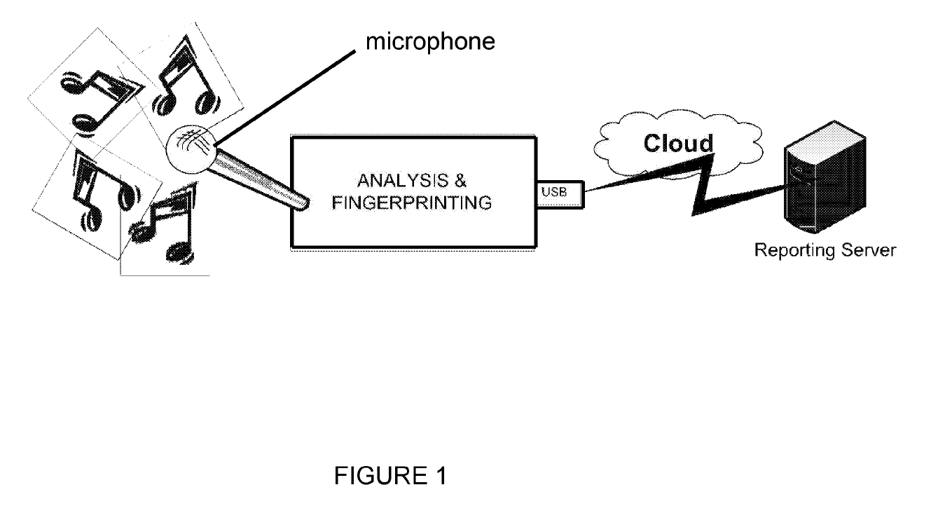

FIG. 1 illustrates an example of a basic process of sounds being recorded by a microphone and passed to an example of the present invention for analysis, resulting in the generation of a digital fingerprint. That fingerprint, along with any additional metadata concerning the environment in which the sounds were recorded, is then passed to a reporting server.

In the example shown in FIG. 1, connectivity to that remote server is provided via a USB port, utilising a preferred embodiment of the connectivity supplied by a device such as one disclosed in WO2012131400A1. In another embodiment, such connectivity may be provided in a different manner, such as by direct access to a mobile phone network via a handset or wirelessly or via 3G functionality embodied within a device containing an example of the present invention, via a CloudStick (a device disclosed in WO2012131400A1; a relevant disclosure is provided in the Appendix) using a non-USB connection, by physically connecting a device implementing an example of the present invention, via USB or any other connection, to the reporting server or to another device which is capable of transmitting the reported data to that reporting server or by any other method of providing connectivity between the device and the remote server.

The essential steps which comprise examples of the method of the present invention are:
1. A microphone records sounds in the vicinity. Such recording may be carried out continuously, in the preferred embodiment, or—in another embodiment—at discrete intervals, whether predetermined or random.
2. An analysis of those sounds is carried out, resulting in a unique digital fingerprint of that sound. In a preferred embodiment, that analysis includes pre-processing steps to clean up the recorded audio and/or video to remove extraneous sounds (such as conversation and/or hisses, crackles and irrelevant ambient sounds) and to enhance the quality of the recording. In a preferred embodiment, such pre-processing and analysis takes place on a device which embodies examples of the present invention. In another embodiment, all or part of such processing takes place on the remote server.
3. The digital fingerprint produced is matched against a database of such fingerprints in order to identify the media content being played. In one embodiment, this step is performed on a device which embodies examples of the present invention, by utilising internet or other connectivity to access a remote database of fingerprints or by utilising an on-device local database of such fingerprints. In a preferred embodiment, this step is undertaken by transmitting the digital fingerprint from the device embodying an example of the present invention to the remote server for identification.
4. Information is stored for reporting purposes, including which media content was identified as being played, linked to one or more of the geographical location where that media content was played, the environment at that location and/or such demographic or other metadata as is available.

In a preferred embodiment, the information about which media content is playing is associated with additional metadata, such as the geographical location in which the media content is playing, the environment (such as an in-car media system, a bar or café, and so forth), such demographics of the listener(s) as are available (such as allowable demographic information about the registered owner of the CloudStick (a device disclosed in WO2012131400A1), if that device is providing the connectivity for the example of the present invention) and any other available metadata, including—in a preferred embodiment—matching a sequence of playing media content against known radio or television station playlist programmes to identify whether (and which) station is being listened to.

In the later example, the present invention may be used in conjunction with, or integrated with, existing radio broadcast monitoring technology to permit the derivation of reports detailing actual listening habits of people rather than simply, as per historical approaches, merely which tracks those stations or channels are broadcasting.

Example embodiments of the present invention include the ability to provide reports detailing which radio, television and movie channels or stations are played; how long each is played before the channel is turned off or changed; which channels are switched between and when; which interstitials and advertisement spots are audibly and/or visibly played (as opposed to being played on, for example, a muted device), where and when and by whom; which internet video sources are watched and/or listened to, where and when and by whom; what the division is between playback of talk radio and music radio stations; and any other relevant metadata, whether directly available or calculated.

In a preferred embodiment of the present invention, in order to ensure that any privacy concerns are met then any such metadata is anonymised to the desired extent—and to at least the extent required by law—prior to being stored and/or transmitted and/or incorporated in reports. Similarly, any audio recordings are transmitted, in a preferred embodiment of the present invention, solely in abstracted form—such as, in a preferred embodiment, in the form of a digital fingerprint of the audio rather than the audio itself—in order further to allay any potential privacy concerns.

Having identified both the media content playing and the environment in which that media content is playing, an implementation of the present invention may then, in a preferred embodiment, generate reports for use by radio and television stations, media content producers and any other interested parties.

### Example Embodiments in Devices

### Mobile Handsets

In one example embodiment, the present invention is integrated into a mobile device, such as a mobile telephone handset, a smartphone, a tablet or laptop computer or any other mobile device.

In this embodiment, the present invention utilises the hardware of the device and may either utilise the device's connectivity and/or microphone or may supply one or both facilities itself. In one example embodiment, the present invention allows the mobile device to access the microphone and/or connectivity provided by the present invention itself.

### Example Embodiments in Devices

### In-Car Entertainment Systems

In one example embodiment, the present invention is embodied in a device which is embedded in—or (in a preferred embodiment) connected to, for example via a USB connection—the in-vehicle media system of a car, bus, coach, boat or other vehicle.

An implementation of the present invention may then—directly or, in a preferred embodiment, via a related or integrated device such as a CloudStick (a device disclosed in WO2012131400A1)—both provide media content tracking and reporting capabilities and, in one embodiment, also provide the in-car media system with access to connectivity and/or a remote media content catalogue to augment or replace the vehicle's existing media system, if any.

### Example Embodiments in Devices—

### In-Venue Systems

In one example implementation of the present invention, royalty collection bodies, such as the Performing Right Society (PRS), will be able to replace or augment their current, largely manual and highly labour-intensive, system of monitoring playback in bars, clubs, restaurants and cafes and other licensed venues by use of the automatic analyses provided by implementations of the present invention.

Since examples of the present invention operate at the user level—collecting data about what people are actually listening to and where and when—rather than at a gross audience level, it also permits the recording of what media content is played even when the choice of that media content is interactive, such as when selected on the fly by DJs, via a jukebox or other interactive mechanisms.

In one example embodiment, the present invention is integrated into a device which is located in a venue licensed to play media content (music and/or video or other media content) and listens to which media content is being played, providing a report to royalty collection agencies. In one version of that embodiment of the present invention, the device's report includes metadata—such as device identifier and/or GPS location information—to exactly identify the location in which that media content is played.

That embodiment also allows royalties collected to be automatically distributed to the correct artists rather than, as happened historically, a blanket fee being collected and then divided generally according to less specific criteria (and approach historically used since, prior to the present invention, it was impossible to identify the actual music played in any specific venue at any given time).

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

### APPENDIX

A system is provided for providing a device access to a digital media content catalogue. The system is a microprocessor based system for providing a media player with access to remotely-stored digital media content and/or its associated metadata (collectively, the “content”) whereby (a) the system is capable of accessing the content; (b) the media player is provided, by the system, with a suitable interface, accessible by that media player, for interacting with the content.

One implementation of the system is called ‘Cloudstick’. CloudStick encapsulates one or more of the following components:
A connection between the CloudStick and the media player device.
A connection between the CloudStick and the digital media content catalogue.
Storage, to hold digital media content (and associated files, such as DRM keys and licenses).
The CloudStick Agent, which is a software component which manages the connections between the digital media content catalogue and the device such that the device views the digital media content catalogue via whatever interface is required by the device. In one example embodiment, the CloudStick acts as a proxy between the device and the online digital media content catalogue. In one example embodiment, the CloudStick acts as a protocol mediating proxy for the device, with the capability of streaming digital media content which providing the device with a view of that stream as if it were a locally-stored file.
A digital media player, whether resident on the device or on the CloudStick.

Other optional features include the following:
the media player is connected to a network, the media player is not connected to a network or the media player is intermittently connected to a network.
the suitable interface presented to the media player consists of one or more of

the following, or some combination thereof: a USB connection, and related technologies, such as mini-USB and micro-USB connections of whatever version, whether or not presented as a Mass Storage Interface to the media player, a Wireless USB connection; a Secure Digital card connection or similar technology, such as an SDHC card, a MicroSD card, a MiniSD card, a Memory Stick or an SDIO (Secure Digital Input/Output) card; a wireless connection to the media player, utilising WiFi, BlueTooth, a Wireless LAN or other wireless connections; an Ethernet cable; an eSATA connection; a mobile media player connection such as an iPod™ or iPhone™ hub or any other appropriate connection; a DLNA (Digital Living Network Alliance) capable interface; a DVI (Digital Video Interface) connection; a HDMI (High-Definition Multimedia Interface) connection; an infra-red or other non-visible light based interface; an IEEE 1394 (“FireWire™”, “i.Link™”, “Lynx™) interface; a smart card connection, such as an RFID interface or related wired or wireless technologies; any NFC (Near Field Communication) technologies, such as an RFID interface or related wireless technologies; any other mechanism which may be used to provide a communications facility between the system and the media player.
the suitable interface presented to the media player includes a coaxial aerial connector or an audio input terminal or any other suitable connection, whether analogue or digital.
the selection as to which interface(s) to present to the media player is made manually.
the selection as to which interface(s) to present to the media player is made automatically based on the capabilities of the media player—whether those capabilities are detected by the system or retrieved via a lookup of the media player's capabilities based on identifying information about the media player, however obtained or retrieved—or by any other suitable criteria.
the system accesses the content via one or more off a direct connection, a wireless connection, such as wifi; a wireless network; a mobile network; an internet connection; 2G, 2.5G, 3G, 4G, EDGE, Wifi, wireless LAN access, Bluetooth, 802.11a/b/g, LTE (3GPP Long Term Evolution), LTE Advanced or any mechanism which provides communications via any other wired or wireless communications protocol or method.
the selection as to which method of connectivity to use by the system to access the content is determined manually.
the selection as to which method of connectivity to use by the system to access the content is determined automatically based on connection strength, tariff costs, location, connection speed or by any other suitable criteria.
the system houses or otherwise utilises one or more active SIM (Subscriber Identity Module) cards to permit the system to authenticate to a mobile network and so make use of the MNO's (Mobile Network Operator) data connectivity.
the system houses or utilises multiple SIM cards and switches between different mobile network operators, whether that switching is performed manually, at user instigation or automatically, based on location, tariffs or any other considerations.
interacting with the content (which term includes any associated metadata) includes one or more of: searching the content; browsing the content; retrieving the content; playing the content using the media player, making the content available for playback by any other capable media player, or any other suitable manner of interacting with the content.
the content is made available via a digital media content subscription service AND the system is capable of registering or logging into that service if required.
the system accesses and/or maintains subscription information and/or digital media content entitlements for the user or users of the system with regard to the service or services with which the system is registered and/or connected to.
the associated metadata includes one or more off the title(s), artist(s), composer(s), genre(s), style(s) of items of digital media content; any files, keys or information required to access items of digital media content, whether protected by DRM technology or not, as required; playlists or any other groupings of digital media content; any other metadata related to items of digital media content or groupings thereof.
the associated metadata includes in addition of one or more of the following: user profiles, messages, recommendations, social network-related data or functionality, album listings, movie details, television schedules, theatrical listings, news, the making and obtaining of recommendations and/or playlists and any other data made available due to the system's connectivity and/or accessible to the system via a service.
the system allow synchronisation, whether manual or automatic, between the user's preferences and/or any other associated metadata on the system and in the digital media catalogue.
the online connectivity provided by the system is made available to the media player and/or to the system for other purposes, such as social networking functions and web browsing, whether generally or only to specifically authorised applications.
the system contains a protected and/or encrypted store, used to hold one or more of: DRM licences and keys, system configuration settings, system registration details, system bindings, digital media catalogue licensing or subscription files and any other files which are deemed either to be sensitive as to their content or non-useful to be visible to the end user or which are stored in that protected store for any other reason.
the system uses its network connectivity to download, progressively download and/or stream the content.
the system acts as a proxy or a protocol mediation proxy between one or more online digital media collections and the media player to which the system is connected.
content—including digital media content, any associated metadata, social networking data or any other retrieved data, as required—is cached for future use, whether cached directly on the system or on some suitable alternative, such as Network Attached Storage or the media player.
cached data is used to provide the system with access to content and/or associated metadata when “offline” (when online connectivity is unavailable), such as when travelling on some planes and underground railways or when connectivity is disabled, whether manually or automatically.
the system intelligently reclaims storage space by identifying that content which was least-recently accessed/played and/or which the user (or his/her associated community, whether via social network rating or otherwise) has rated as being least popular and then deleting, archiving (moving to a separate storage system) or overwriting such media content in order to utilise its storage space for more recently requested metadata or files.
the media player communicates with the system via an Application Programming Interface (API) provided by the system to the media player for that purpose.
the API provided by the system to the media player allows the media player to interact with a remote digital media content catalogue and/or a service via the system.
the API provided by the system to the player mimics file system operations undertaken by the media player, including but not limited to a search by the media player of what appears to the media player to be a local file system being managed by the system as a remote search of a digital media catalogue, with the search results presented by the system to the media player in a form consonant with the media player's capabilities, such as by providing the media player with a virtual file system containing the search results or placeholders thereof or by any other appropriate means.
the system performs protocol mediation such that media content may be downloaded or streamed to the system from a remote server but presented to the media player as if it were a locally stored file.
the system permits content to be broadcast to one or more suitable media players, whether connected directly or wirelessly, including but not limited to broadcasting to one or more DLNA-capable media players.
the system is capable of communicating, directly or wirelessly or by any other appropriate means, with other systems and/or media players to permit sharing of content, including associated metadata; shared caching of content; or for any other suitable purpose.
the system scans and/or identifies any digital media content stored on the media player and/or the system and uploads that content or descriptors thereof to one or more remote servers from which that content may be made available to the user's other registered systems and/or media players.
the system incorporates location tracking technology, such as GPS (Global Positioning System), to assist in providing one or more of the following functions: determining which locale-specific digital media catalogue is to be accessed; obtaining access to that catalogue if desired; to automatically, or on request, purchase or otherwise obtain access rights to that catalogue; perform social networking functions; or for any other suitable purpose.
the system functions as a removable or Network Attached storage system and/or interfaces with other such storage systems.
the architecture of the system and/or its controlling software is modular in nature AND may be updated and/or expanded or contracted based on manual or automatic directives, whether initiated manually, automatically by the system or remotely by any suitably authorised service.
the system is adapted to interface with the media player, in which the media player is one or more of the following, or any combination thereof: a computing system; a digital media player, an analogue media player or any system capable of browsing, storing or playing digital and/or analogue media content.
the system is adapted to interface with the media player, in which the media player is a desktop system, such as a computing system, a hi-fi system, a turntable, a television, a games console or any other non-portable system.
the system is adapted to interface with the media player, in which the media player is a portable system, such as an mp3 player, an in-vehicular entertainment system or a handset or any other portable or mobile system.
the system is adapted to interface with the media player, in which the media player is wholly or partially integrated into the system and provides zero, one or more of: connection socket(s) for headphones; a battery; a battery charging mechanism; a screen to display information to the end-user and/or to display images, text and/or video or any combination thereof; operating controls for an on-system media player, remote controls for an on-system media player, facilities for searching, browsing and/or otherwise interacting with a remote digital media content catalogue and/or service; any other suitable provisions.
the system is a portable, personal device.
the system microprocessor is not dedicated to the system but used by other processes or modules that are unrelated to the system.
the system is self-contained in so far as it has own dedicated microprocessor and operating system.
the system is adapted to operate with the media player, in which the media player has no intrinsic ability to access remotely stored content.
the system is adapted to operate with the media player, in which the media player has no intrinsic ability to access remotely stored content and is a legacy third party media player.
the system is packaged as a USB memory stick.

1. A method of identifying media content playing in a vicinity of a device, the method including the steps of:
(a) recording sounds received at the device;
(b) analysing those sounds to determine which media content is playing in the vicinity of the device, and
(c) storing or transmitting results of the analysis to permit a generation of a report as to what specific media content is playing in the vicinity of the device, or was playing in the vicinity of the device.

2. The method of claim 1 where the recording of sounds happens continuously.

3. The method of claim 1 where the recording of sounds happens at discrete intervals, whether automatically or manually triggered.

4. The method of claim 1 where recorded sounds are stored on a device.

5. The method of claim 1 where recorded sounds are transmitted to a remote server for analysis.

6. The method of claim 1 where ambient noise, static, hiss, background noise, unwanted speech and/or any other unwanted sounds are digitally filtered from the recorded sounds prior to their analysis.

7. The method of claim 1 where the recorded sounds are analysed to produce a concise digital description, i.e. a digital fingerprint, of the media content which was recorded.

8. The method of claim 1 where the results arising from the analysis of the recorded sounds are stored on a device.

9. The method of claim 1 where the results arising from the analysis of the recorded sounds are transmitted to a remote server.

10. The method of claim 1 where data which is stored on a device is later transmitted to a remote server.

11. The method of claim 1 where information which is stored on a device or transmitted to a remote server is augmented with metadata including but not limited to one or more of: the geographical location in which the media content is playing, the environment, such demographic information about the listener(s) as is available and any other available metadata.

12. The method of claim 1 where the digital fingerprint produced is matched against a database of such fingerprints in order to identify the media content being played.

13. The method of claim 1 where a sequence of recorded sounds is matched against known radio or television station playlist programmes to identify whether (and which) station or channel is being played in the vicinity of the device.

14. The method of claim 1 where the analysis of the media content played in the vicinity of the device is used to generate reports for use by radio and television stations, media content producers, performance rights societies and any other interested parties.

15. The method of claim 14 where the reports so produced may be used to compile charts of digital media content playbacks, to monitor the licensing of digital media content or to request royalties due on playback or for any other purpose.

16. The method of claim 1 where data transmitted to a remote server is transmitted using a wireless connection, a wired connection or by any other means, including but not limited to Wi-Fi, Bluetooth, the internet or a mobile phone network.

17. The method of claim 1 where the device is a mobile computing device, a laptop, a mobile telephone handset, a music player, an in-vehicular digital media system or any other computing device.

18. Computer program product embodied on a non-transient storage medium, the computer program product when running on a computing device operable to identify media content playing in a vicinity of the computing device, the computer program product when running on the computing device operable to:
(a) record sounds received at the device;
(b) analyse those sounds to determine which media content is playing in the vicinity of the device, and
(c) store or transmit results of the analysis to permit a generation of a report as to what specific media content is playing in the vicinity of the device, or was playing in the vicinity of the device.

19. (canceled)

20. Computing device including a computer program product embodied on a non-transient storage medium, a microphone, and a processor, the computer program product when running on the computing device operable to identify media content playing in a vicinity of the computing device, the computing device configured to:
(a) record sounds received at the device;
(b) analyse those sounds to determine which media content is playing in the vicinity of the device, and
(c) store or transmit results of the analysis to permit a generation of a report as to what specific media content is playing in the vicinity of the device, or was playing in the vicinity of the device.

21. (canceled)
